(19) United States
(12) Patent Application Publication
(10) Pub. No.: US 2011/0058936 A1
(43) Pub. Date: Mar. 10, 2011

(54) TURBINE DUCT ARRANGEMENT

(76) Inventor: Coenraad Hendrik VAN WYK, Strand (ZA)

(21) Appl. No.: 12/875,285

(22) Filed: Sep. 3, 2010

(30) Foreign Application Priority Data
Sep. 4, 2009 (ZA) 2009/06149

(51) Int. Cl. F03D 3/04; F03D 11/00

(52) U.S. Cl. 415/186; 415/208.3

(57) ABSTRACT

A wind turbine duct arrangement having a plurality of frusto-conical ducts each having an open apex and an open base defining an air intake, the ducts radially joined at their apexes to define a convergence zone wherein operatively rotating blades of a turbine may be installed transverse to the plurality of ducts. In use, the turbine duct arrangement provides a combination catchment and channelling area through the open bases of the plurality of ducts for channelling wind intake through the arrangement onto blades of a wind turbine transversely installed in the convergence zone defined by the radially joined apexes of the plurality of ducts.

THIS INVENTION relates to a turbine duct arrangement, particularly a wind turbine duct arrangement, and a turbine duct arrangement installation.

### BACKGROUND OF THE INVENTION

Wind turbines convert kinetic energy into mechanical energy, which in turn is converted to electrical energy by a wind generator. Wind turbines may be classified as horizontal-axis wind turbines (HAWT) and vertical-axis wind turbines (VAWT) according to the axis along which the turbine rotates. The latter includes blades attached to a vertical rotor shaft and connected to an electrical generator for generating electrical power. Most wind turbines include a gearbox that provides a mechanical advantage between the operatively slow rotating blades and the quicker movement required by the drive shaft to drive the electrical generator.

Wind turbines are designed to exploit the wind energy at a specific location. The towers and blades may be up to 90 m long and are sensitive to wind speed, frequency and direction. The sheer size of a wind turbine installation (in particular the blades of such an installation) and the wind forces that act on the installation require the deployment of various mechanisms to reduce fatigue and structural shortcomings of the turbine. To this end, turbines employ anemometers and wind vanes that determine wind speed and direction, upon which a yaw drive acts to orient the blades to operatively face into the wind.

The inventor has identified a need for amplification of wind flow to a wind turbine to allow for the effective use of smaller turbine blades and has identified a need for optimal channelling of omni-directional wind flow in a direction ideally required by the operative faces of the blades of a turbine installation.

### SUMMARY OF THE INVENTION

According to a first aspect of the invention there is provided a turbine duct arrangement which includes:

a plurality of generally frusto-conical ducts each having an open apex and an open base defining an air intake, the ducts radially joined at their apexes to define a convergence zone wherein operatively rotating blades of a turbine may be installed transverse to the plurality of ducts.

The plurality of ducts may be tapered.

The plurality of ducts may be flared at their air intakes.

The plurality of ducts may include deflectors extending from their apexes into the convergence zone for operatively deflecting intake air in a direction tangentially along a perimeter of the convergence zone.

Thus, in use, wind would enter the duct arrangement through the air intakes of the ducts and be channelled into the convergence zone via the open apexes of the ducts and in a direction generally tangentially along the perimeter of the convergence zone such that airflow is advantageously directed onto operative faces the rotating blades of the turbine.

In one embodiment of the invention, the deflectors may include deflection plates mounted to the open apexes of the ducts. In another embodiment, deflectors may be defined by a curvature of the open apexes, the curvature extending in a direction generally tangential with the perimeter of the convergence zone to operatively deflect intake air onto the operative faces of the blades of the turbine.

The turbine duct arrangement may include a mount for mounting the arrangement on a support structure. The support structure may include an existing support structure, including but not limited to an irrigation pivot and a greenhouse.

The turbine duct arrangement may include a stacked plurality of the duct arrangements.

The convergence zone defined by the radially joined apexes of the ducts may be substantially round to snugly encompass the blades of the turbine.

The ducts of the arrangement may be integrally moulded and manufactured of a light-weight material, such as fibre-glass or plastic.

The ducts of the arrangement may be at least partly collapsed for optimal stacking of the stacked plurality of ducts. To this end, the ducts may be convex in end cross-section. The ducts of the stacked plurality of duct arrangements may be adjoined in honeycomb fashion.

According to another aspect of the invention there is provided a turbine duct arrangement installation which includes:

a turbine duct arrangement as hereinbefore described, the turbine duct arrangement installed on a support structure; and

a vertical axis turbine installed in the convergence zone defined by the open apexes of the ducts of the arrangement and having turbine blades installed transverse to the plurality of ducts.

The turbine duct arrangement installation may include a generator attached to a rotor shaft of the turbine.

The invention is now described, by way of non-limiting example, with reference to the accompanying diagrammatic drawings.

### DRAWINGS

### In the Drawings

FIG. 1 shows a schematic sectional top view of a turbine duct arrangement in accordance with one aspect of the invention;

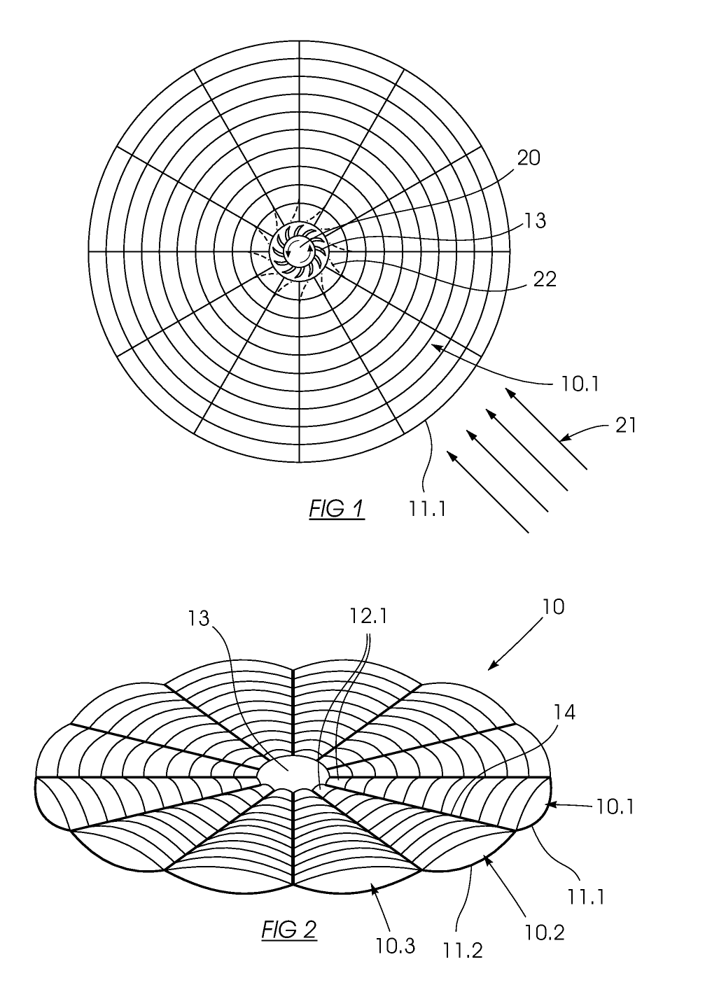

FIG. 2 shows a schematic perspective view of a turbine duct arrangement in accordance with one aspect of the invention;

FIG. 3 shows an enlarged portion of the sectional top view of the turbine duct arrangement according to the embodiment of the invention of FIG. 2;

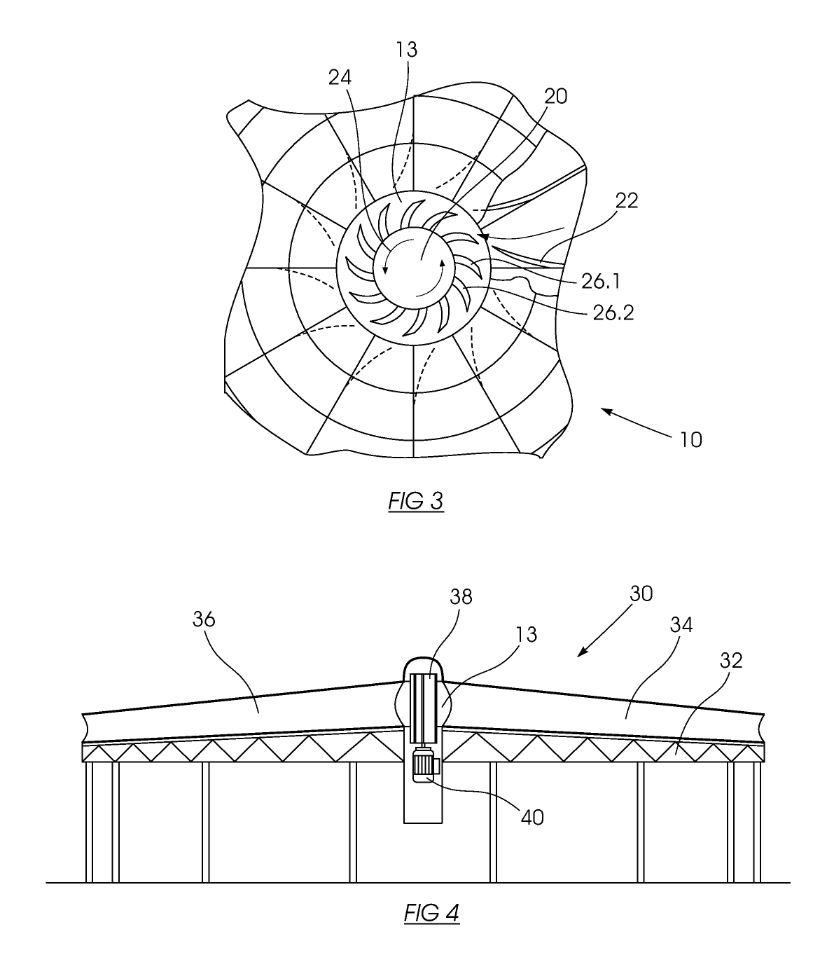

FIG. 4 shows a sectional side view of a duct arrangement installation in accordance with another aspect of the invention.

In the figures, like reference numerals denote like parts of the invention, unless otherwise indicated.

### DETAILED DESCRIPTION OF THE INVENTION

Referring firstly to FIG. 2, reference numeral 10 generally denotes a turbine duct arrangement according to one embodiment of an aspect of the invention. The duct arrangement 10 has a plurality of radially converging, generally conical ducts of which three are indicated by 10.1, 10.2 and 10.3. The generally conical ducts have open bases (of which two are denoted as by 11.1 and 11.2) defining air intakes about a perimeter of the duct arrangement 10 and open apexes (of which only two are denoted by 12.1 and 12.2) at a convergence zone 13 defined by the radially joined apexes of the plurality of ducts 10.1, 10.2 and 10.3.

The ducts 10.1 and 10.2 are laterally interconnected at 14 such that the ducts 10.1 and 10.2 converge at their apexes 12.1 and 12.2 at the convergence zone 13 and are collapsed such that when viewed from the open bases 11.1 and 11.2, the ducts are convexly shaped in cross-sectional end view. A wind turbine may be operatively installed in the convergence zone 13 such that the duct arrangement 10 is located transverse to an operatively rotating axis and blades of the wind turbine (not shown here) as will become more apparent in the figures that follow.

The plurality of conical ducts (of which two are denoted by 10.1 and 10.2) each taper inwardly from their respective open bases 11.1 and 11.2 to converge at the convergence zone 13 and are manufactured of a light-weight fibre-glass material.

Referring now to FIG. 1 of the drawings, a sectional top view of the duct arrangement 10 of FIG. 1 is shown to include a wind turbine 20 for illustrative purposes. In use, the conical ducts (of which only one is denoted by 10.1) of the turbine duct arrangement 10 accept wind flow from a direction indicated by 21 through its open base 11.1 and channel the wind flow through the duct 10.1 to the wind turbine 20 located in the opening 13 transverse to the duct arrangement 10. The conical ducts (exemplified by 10.1) include deflection means in the form of deflection plates (exemplified by a deflection plate 22 of the duct 10.1) for operatively deflecting the intake air 21 in a direction generally along and tangential to the perimeter of the convergence zone 13. In this embodiment, the blades of the wind turbine 20 operatively rotate anti-clockwise, and hence the intake air is deflected in an anti-clockwise direction along the perimeter of the convergence zone 13 so that the air flow is wholly directed onto operative faces of the blades of the wind turbine 20.

FIG. 3 shows an enlarged sectional top view portion of the turbine duct arrangement 10 shown in FIG. 2, the enlarged portion including the wind turbine 20 operatively installed in the convergence zone 13 for illustrative purposes. In the figure, the deflection plates, of which one is indicated by numeral 22, can clearly be seen and are operable to direct wind flow from the air intake 21 in the direction along the perimeter of the opening 13, particularly in an anti-clockwise direction 24 such that the wind flow is directed onto operative faces of the operatively rotating blades 26.1 and 26.2.

Referring now to FIG. 4 of the drawings, numeral 30 generally denotes a turbine duct arrangement installation in accordance with another aspect of the invention. The installation 30 includes the duct arrangement 10 of FIGS. 1 through 3, the arrangement 10 installed on an existing support structure, in this embodiment an irrigation pivot 32. Installation of the duct arrangement 10 on the pivot 32 raises the duct arrangement 10 from the ground and locates the arrangement 10 at a height of ideal operative wind speeds. To this end, the duct arrangement includes attachment means in the form of a mount (not shown here) for installing the duct arrangement 10 on the irrigation pivot 32. The generally conical ducts of the arrangement 10 are seen in cross-sectional side elevation at 34 and 36. The installation 30 includes a vertical-axis turbine 38 installed transverse and into the convergence zone 13 defined by the radically converging conical ducts of the duct arrangement 10. A rotor shaft of the vertical-axis turbine 38 is attached to a generator 40 for generating electrical power.

Advantageously, a turbine duct arrangement installation as hereinbefore described provides a large air catchment area through the open bases of the plurality of radially converging ducts and provides for wind intake from all directions, whereafter the wind is channelled in one direction operable to efficiently drive the blades of a turbine, thereby effectively lowering blade size and operating costs associated with fatigue and operational stresses on blades of a much larger size. Additionally, the invention as described eliminates the requirement for rotating operative faces of wind turbine blades into a direction of wind flow.

1. A turbine duct arrangement which includes:
a plurality of generally frusto-conical tapered ducts each having an open apex and an open base defining an air intake, the ducts radially joined at their apexes to define a planar convergence zone wherein operatively rotating blades of a turbine may be installed transverse to the plurality of ducts.

2. A turbine duct arrangement as claimed in claim 1 wherein the plurality of ducts are flared at their air intakes.

3. A turbine duct arrangement as claimed in claim 1 wherein the plurality of ducts include a deflector extending from the apexes of the ducts into the convergence zone for operatively deflecting intake air in a direction tangentially along a perimeter of the convergence zone.

4. A turbine duct arrangement as claimed in claim 1 which includes a mount for installing the arrangement on a support structure including any one of an irrigation pivot and a greenhouse.

5. A turbine duct arrangement as claimed in claim 1 wherein the plurality of ducts are a stacked plurality of ducts.

6. A turbine duct arrangement as claimed in claim 1 wherein the convergence zone defined by the radially joined apexes of the ducts is substantially round for snugly encompassing the blades of the turbine.

7. A turbine duct arrangement as claimed in claim 1 that is integrally moulded of a light-weight material including any one of plastic and fibre-glass.

8. A turbine duct arrangement as claimed in claim 5 wherein ducts of the stacked plurality of ducts are at least partially collapsed and convex in end cross-section such that the stacked plurality resembles a honeycomb-fashioned stack.

9. A turbine duct arrangement as claimed in claim 3 wherein the deflector is a deflection plate.

10. A turbine duct arrangement as claimed in claim 3 wherein the deflector is defined by a curvature of the open apexes of the ducts, the curvature extending in a direction generally tangential with the perimeter of the convergence zone to operatively deflect intake air onto operative faces of the blades of the turbine.

11. A turbine duct arrangement installation which includes:
a turbine duct arrangement as claimed in claim 1, the duct arrangement installed on a support structure; and
a vertical axis turbine installed in the convergence zone defined by the apexes of the ducts of the arrangement and having turbine blades installed transverse to the plurality of ducts.

12. A turbine duct installation as claimed in claim 11 which includes a generator attached to a rotor shaft of the turbine.
